(19) United States
(12) Patent Application Publication
(10) Pub. No.: US 2010/0074315 A1
(43) Pub. Date: Mar. 25, 2010

(54) NOISE SAMPLING DETECTORS

(75) Inventor: Wilhelm Steffen Hahn, Los Altos, CA (US)

Correspondence Address: KING & SPALDING, 1180 PEACHTREE STREET , NE, ATLANTA, GA, 30309-3521, US

(73) Assignee: QUELLAN, INC., Santa Clara, CA (US)

(21) Appl. No.: 12/236,945

(22) Filed: Sep. 24, 2008

(51) Int. Cl. H04B 3/46

(52) U.S. Cl. 375/227

(57) ABSTRACT

A noise sampling detector suitable for portable electronic devices is disclosed. The detector may detect noise, transmitter signals, spurs, and/or interference. In one embodiment, a detector can include: a load portion; an antenna pattern shaping portion coupled to the load portion, where the antenna pattern shaping portion includes meandering segments of variable lengths and/or widths; and an impedance matching circuit coupled to the antenna pattern shaping portion.

### FIELD OF THE INVENTION

The invention relates in general to noise cancellation associated with electronic devices, and more specifically to noise sampling detectors in electronic systems.

### BACKGROUND

Portable computing or electronic devices typically include antennas that are tuned to receive signals having certain frequencies. However, electromagnetic interference (EMI) disturbances emitted from external and/or internal sources can affect electrical circuits due to electromagnetic radiation. Such disturbances may interrupt, obstruct, or otherwise degrade or limit effective circuit performance. Thus, circuits in electronic devices, such as global positioning system (GPS) receivers, phones, personal digital assistants (PDAs), small computers, e-mail devices, audio players, video players, etc., should be protected from potentially harmful EMI.

### SUMMARY

A noise sampling detector suitable for portable electronic devices is disclosed. The detector may detect noise, transmitter signals, spurs, and other interference. In one embodiment, the detector can include: a load portion; an antenna pattern shaping portion coupled to the load portion, where the antenna pattern shaping portion includes meandering segments of variable lengths and/or widths; and an impedance matching circuit coupled to the antenna pattern shaping portion.

In one embodiment, the antenna pattern shaping portion can include one or more notches on each side in a square stub arrangement for adjustment of resonance frequency.

In one embodiment, a system for detecting and canceling noise can include: means for receiving an electromagnetic signal for a first signal path; means for amplifying and filtering the received signal to provide an amplified signal; means for detecting noise in a second signal path; and means for canceling the detected noise from the first signal path.

### BRIEF DESCRIPTION OF THE DRAWINGS

FIG. 1 is a block schematic diagram showing an example noise sampling detector application.

FIG. 2 is a diagram showing an example antenna pattern from a multilayer detector device.

FIG. 3 is a diagram showing an example antenna pattern from a thin detector device.

FIG. 4 is a diagram showing an example parameterized ultrathin detector (UTD) arrangement.

FIG. 5 is a picture diagram showing a first example UTD.

FIG. 6 is a picture diagram showing a second example UTD.

FIG. 7 is a picture diagram showing a third example UTD.

FIG. 8 is a diagram showing an example parameterized GPS square stub detector arrangement.

FIG. 9 is a picture diagram showing a first example GPS square stub detector.

FIG. 10 is a picture diagram showing a second example GPS square stub detector.

FIG. 11 is a picture diagram showing a third example GPS square stub detector.

FIG. 12 is a picture diagram showing a fourth example GPS square stub detector.

FIG. 13 is a picture diagram showing a first example dipole detector.

FIG. 14 is a picture diagram showing a second example dipole detector.

FIG. 15 is a picture diagram showing a third example dipole detector.

FIG. 16 is a picture diagram showing a fourth example dipole detector.

FIG. 17 is a picture diagram showing a fifth example dipole detector.

FIG. 18 is a flow diagram showing an example method of using a detector.

FIG. 19 is an example simulated antenna pattern diagram.

### DETAILED DESCRIPTION

Particular embodiments can provide detection of noise, interference, transmitter signals, and/or spurs, such as for cancellation in association with an antenna module. Various detector designs can be utilized to effectively target particular antenna patterns or characteristics for noise signal detection. As described herein, the various detectors may have different form factors to adapt to the particular area constraints of different applications.

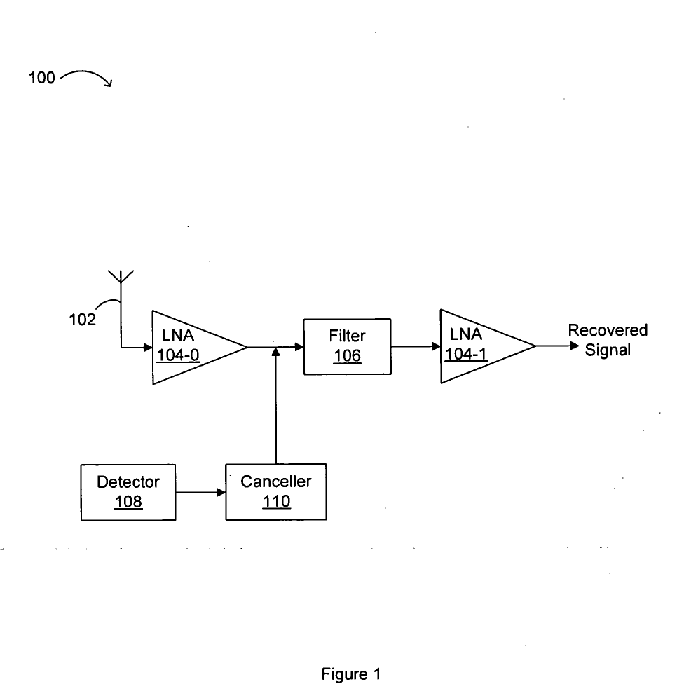

Referring now to FIG. 1, a block schematic diagram of an example noise sampling detector application 100 is shown. In this particular application, an antenna module used in the global positioning system (GPS) can include a patch antenna 102 that receives an electromagnetic signal, and provides a received signal to a first low noise amplifier (LNA) 104-0. A filter 106 (e.g., a surface acoustic wave (SAW) filter, a bandpass filter, etc.) can receive an amplified signal from the first LNA, and provide a signal to a second LNA 104-1 for coupling the recovered signal to a coaxial cable.

Of course, many variations of the particular example shown in FIG. 1 may be found in certain embodiments. For example, multiple or different types of filters, other types of amplifiers, ordering of filter and amplifier devices or components, as well as different connection points (e.g., along a radio frequency (RF) signal path) for the noise canceller and detector can be selected. In one example, the active GPS antenna may not include the second LNA, but rather the second LNA may be part of an RF integrated circuit (RF-IC) on a main printed circuit board (PCB). In other examples, other types of circuitry for amplification or other functions can be used. Further, the detector and noise canceller as described herein can also detect and cancel interference, transmitter signals, and spurs.

In particular embodiments, an active GPS noise canceller antenna structure can include a noise canceller 110 and detector 108 that are mated to, otherwise integrated with, or otherwise associated with, the antenna module. Thus, a standalone module can be created with an appropriate detector, such as an ultrathin detector (UTD), added to an active antenna. The noise canceller 110 with detector 108 may be placed as close as possible to the active antenna, such as in an arrangement on or with a common PCB as the active/patch antenna. Alternatively, the noise canceller and detector can be placed on a shield covering the active antenna. Such placement can ensure good correlation between the noise signatures, resulting in good cancellation.

A bus (e.g., a serial peripheral interface (SPI), a universal serial bus (USB), inter-integrated circuit bus (I²C), etc.) may be used for communication to another component in order to optimize cancellation. Alternatively, a fixed setting may be stored in local memory, such as a nonvolatile type of memory (e.g., electrically erasable programmable read-only memory (EEPROM) flash memory, etc.) of an associated host system such that setting information can be downloaded into the device. Such a fixed setting can include information (e.g., gain, absolute temperature, temperature coefficient, etc.) about frequencies or other signal characteristics for cancellation. Alternatively, such memory (e.g., flash memory) may be located inside the noise detection and cancelling module, or be contained in the noise canceller IC itself.

In any event, the noise canceller may be connected to a standard GPS chip/chipset, such as any available from MediaTEK, SiRF, Epson, Broadcom, etc., such that that the antenna and the LNA are relatively close together. Such a configuration provides low losses while retaining good reception.

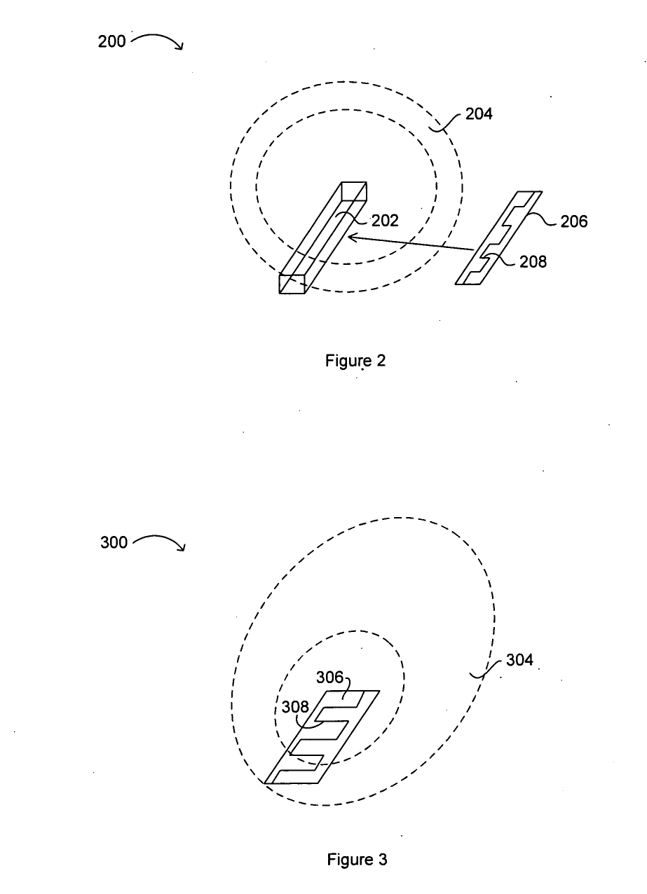

Referring now to FIG. 2, a diagram of an example antenna pattern from a multilayer detector device is shown (200). Detector 202 can include multiple layers 206 of meandering patterns 208 placed on top of one another. Segments, patterns, or traces 208 may thus be formed in each layer in a meandering pattern. Antenna pattern 204 may result from this detector arrangement by superimposition of component patterns from each segment in the meandering pattern, for each layer. As such, lengths and widths of the meandering segments can affect parts of the antenna pattern. For example, antenna pattern 204 can be a circular wheel type of structure.

Referring now to FIG. 3, a diagram of an example antenna pattern from a thin detector device is shown (300). For comparison purposes to FIG. 2, a single layer 306 in FIG. 3 may be used to form UTD. With UTD 306, the wheel-like structure 204 of FIG. 2 becomes (in FIG. 3, based on UTD 306) flatter, may avoid tilting, and can be spread further. Accordingly, a resulting characteristic 304 is more flat and not round like antenna pattern 204. In this fashion, antenna directivity can be achieved in order to catch local interference in relatively close fields.

Antenna pattern or characteristic 304 is thus much shorter, smaller and closer-in as compared to antenna pattern 204 from multilayer detector 202. The antenna pattern 304 may result from the arrangement of UTD 306 by superimposition of component patterns from each segment 308 in the meandering pattern. As such, lengths and widths of the meandering segments can affect parts of the antenna pattern 304.

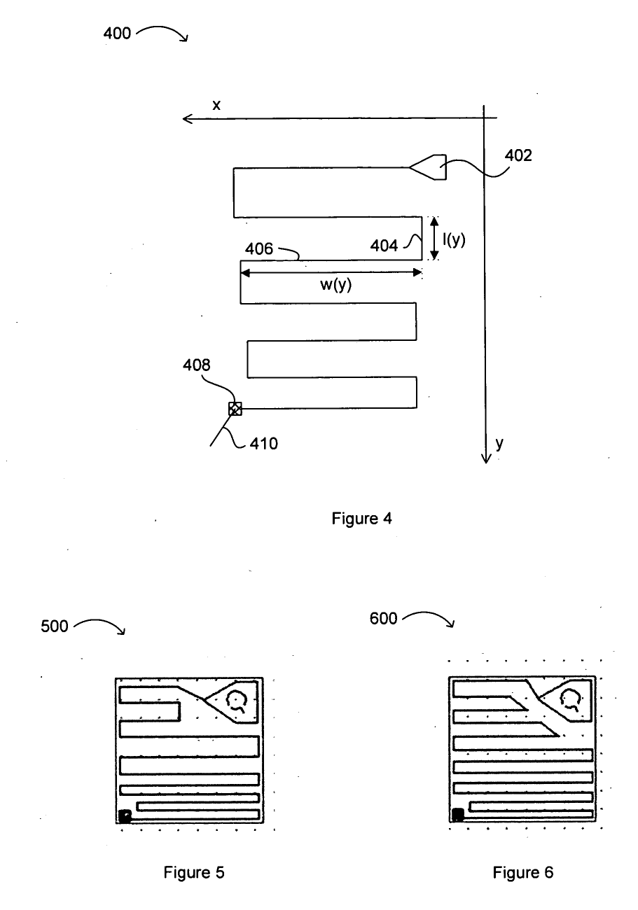

Referring now to FIG. 4, a diagram of an example parameterized UTD arrangement 400 is shown. In particular embodiments, a UTD includes: load portion 402; an antenna pattern shaping portion made up of meandering segments (e.g., 404, 406, etc.); and an impedance matching circuit 410. For example, impedance matching circuit 410 can include a transformer, or a series or shunt inductor, coupled to connection or feed point 408.

Particular embodiments can include meandering segments with variable lengths thereof, where the segment lengths can affect a shape of the antenna pattern/characteristic. Further, the meander spacing can affect a frequency response of the detector. Thus, a length of a meandering segment (e.g., 404) may vary as a function of dimension “y” such that I(y) can be adjusted for shaping of the frequency characteristic by broadening or narrowing a bandwidth. Similarly, a width of a meandering segment (e.g., 406) may also vary as a function of dimension “y” such that w(y) can shape the antenna pattern or frequency response.

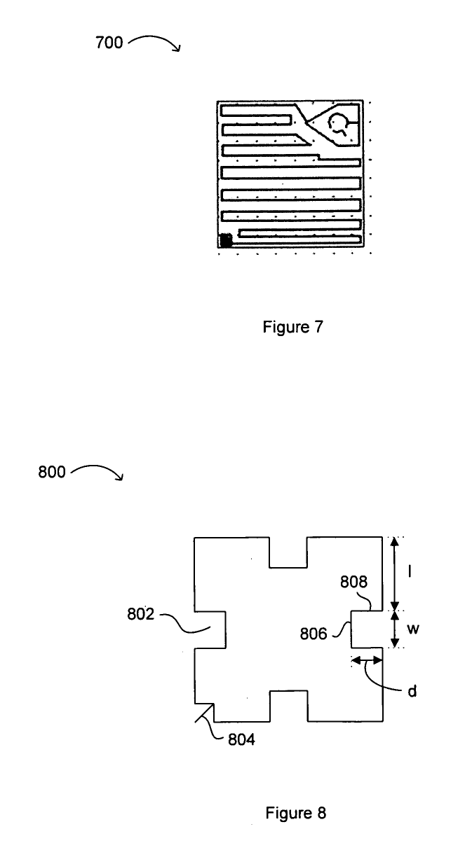

Referring now to FIGS. 5-7, picture diagrams of the example UTDs are shown. FIG. 5 shows a first example UTD 500, FIG. 6 shows a second example UTD 600, and FIG. 7 shows a third example UTD 700.

In these examples, UTDs 500, 600, and/or 700 can have dimensions of about 20 mm by about 20 mm, and a thickness of about 50 μm. Of course, any suitable dimensions can be utilized, such as ranging from about 10 mm to about 30 mm, including about 15 mm to about 25 mm, as well as thicknesses less than about 100 μm, and including less than about 75 μm. In addition, each detector may be on a ground plane that is slightly bigger than meandering portions of the structures 500, 600, and 700, such as shown in the respective bounding boxes. The ground plane may be connected to the impedance matching circuit, and can also serve as a stand-off for mechanical purposes.

Impedances of antennas are typically matched to about 50 Ω, while the intrinsic detector may be as low as, e.g., about 4 Ω. Thus, matching elements, such as transformers, inductors, and/or capacitors, can be used to shift the impedance to an appropriate level. Particular embodiments can support any suitable impedance matching, such as impedances ranging from about 1 Ω to about 30 Ω, including from about 2.5 Ω to about 20 Ω, such as from about 3 Ω to about 10 Ω. Thus, detectors of particular embodiments can be used in a variety of different products with different impedances.

Substrate materials for detectors can include silicon, oxide, gallium arsenide, glass, ceramic, Kapton polyimide film, and PCB materials, such as thin copper foil conducting layers, and insulating layers laminated together with epoxy resin. Various materials used in making PCBs include: FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (woven glass and epoxy), CEM-4 (woven glass and epoxy), and CEM-5 (woven glass and polyester).

Referring now to FIG. 8, a diagram of an example parameterized GPS square stub detector arrangement 800 is shown. Such a GPS square stub detector may be a relatively small band detector configured to obtain resonance gain. As will be shown in the examples below, the trace loop can be with or without impedance matching circuitry inside the loop. Thus in some cases, the impedance matching circuitry is outside of the loop (see, e.g., impedance matching circuitry 804). Impedance matching circuitry 804 can be located and/or tapped in any suitable position to make an appropriate transformation.

Notches 802 can be used for resonance frequency adjustment by increasing or decreasing an overall loop length. Notch dimensions, such as 806 (notch width (w)) and 808 (notch depth (d)), as well as vertex length (I), may also be varied for resonance frequency adjustment. For example, an asymmetrical or a symmetrical number of notches 802 may be included in detector 800. Adjustment of a resonance frequency or a frequency of highest sensitivity can be made by varying notches 802, such as by altering widths 806 and/or depths 808.

Similar to the discussion above, square stub detectors also have a ground plane, and the materials used in making these detectors may also be as described above. Generally, such a square stub type of detector may be used in handheld personal digital assistants (PDAs) due to the form factor involved, as well as other suitable devices.

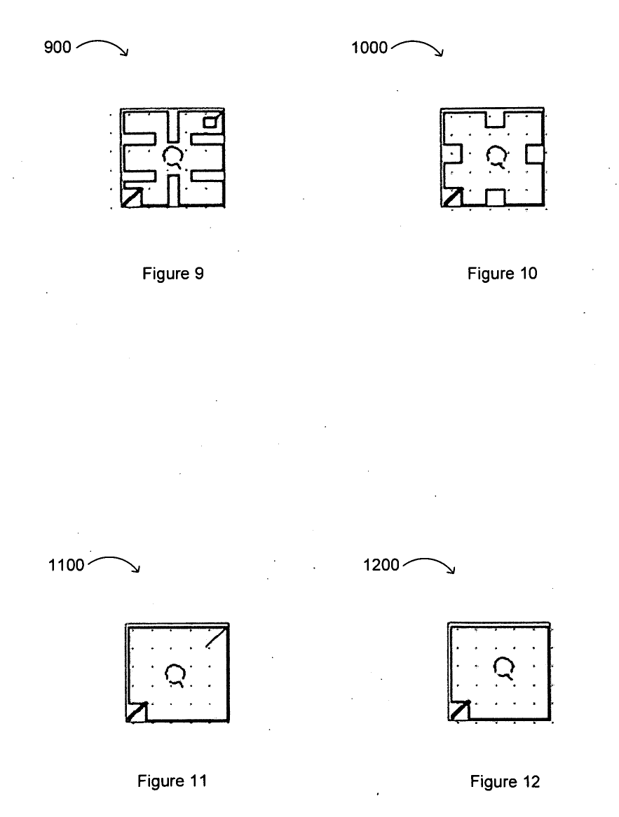

Referring now to FIGS. 9-12, picture diagrams of example GPS square stub detectors are shown. FIG. 9 shows a first example GPS square stub detector 900, FIG. 10 shows a second example GPS square stub detector 1000, FIG. 11 shows a third example GPS square stub detector 1100, and FIG. 12 shows a fourth example GPS square stub detector 1200.

In these examples, square stub detectors 900, 1000, 1100, and/or 1200, can have dimensions of about 14 mm by about 14 mm, and thicknesses of about 50 μm. Of course, any suitable dimensions can be utilized, such as ranging from about 5 mm to about 25 mm, including about 10 mm to about 20 mm, as well as thicknesses less than about 100 μm, and including less than about 75 μm.

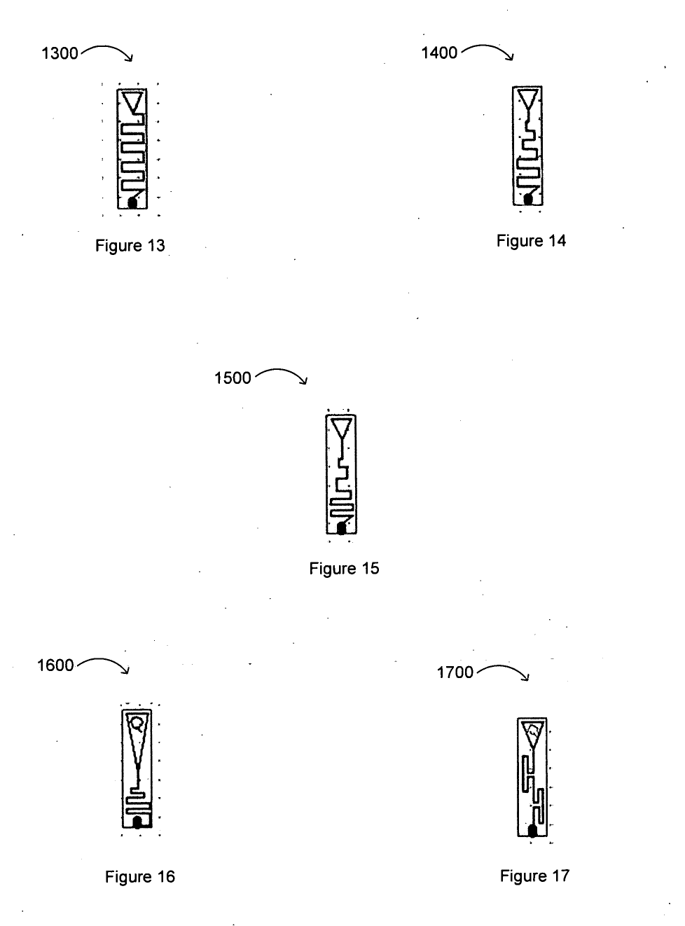

Referring now to FIGS. 13-17, picture diagrams of example dipole detectors are shown. FIG. 13 shows a first example dipole detector 1300, FIG. 14 shows a second example dipole detector 1400, FIG. 15 shows a third example dipole detector 1500, FIG. 16 shows a fourth example dipole detector 1600, and FIG. 17 shows a fifth example dipole detector 1700.

In these examples, dipole detectors 1300, 1400, 1500, 1600, and/or 1700, can have dimensions of about 4 mm by about 16 mm, and a thickness of about 50 μm. Of course, any suitable dimensions can be utilized, such as ranging from about 1 mm to about 30 mm, including about 2 mm to about 25 mm, as well as thicknesses less than about 100 μm, and including less than about 75 μm.

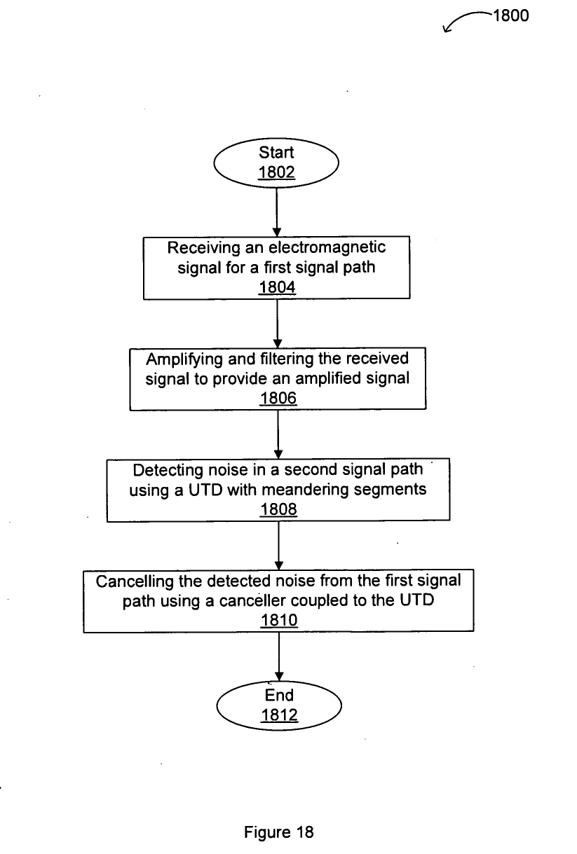

Referring now to FIG. 18, a flow diagram of an example method 1800 of using a detector is shown. This particular detector usage example may correspond to the block schematic diagram of FIG. 1. In FIG. 18, the flow begins (1802), and an electromagnetic signal for a first signal path can be received (1804). The received signal can be amplified and filtered to provide an amplified signal (1806). Noise, interference, transmitter signals, and/or spurs, can be detected in a second signal path, such as by using a UTD with meandering segments (1808). The detected noise can then be canceled from the first signal path using a canceller coupled to the UTD (1810), completing the flow (1812).

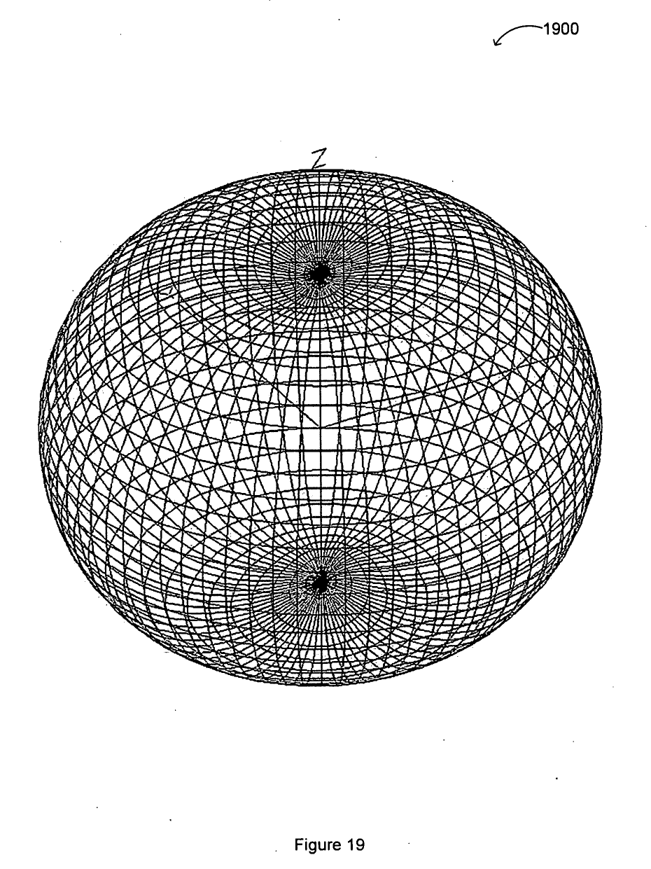

FIG. 19 shows an example simulated antenna pattern diagram. For example, the antenna pattern of FIG. 19 can represent a simulated antenna pattern for detector 306 of FIG. 3. As ground planes become smaller, the antenna pattern becomes flatter, as discussed above.

Detector designs as described herein allow for ultrathin devices that fit into relatively small form factor devices. In particular embodiments, detection of noise that might otherwise interfere with other signals on board can occur, and the detected noise signals can then be cancelled so as to avoid interference. Various aspects may be suited to antenna modules, or any other applications where noise, interference, transmitter signals, and/or spurs should be detected.

Although particular embodiments of the invention have been described, variations of such embodiments are possible and are within the scope of the invention. For example, although particular detector arrangements and structures have been described and shown, other segment patterning and the like can also be accommodated in accordance with various aspects. For example, while particular meandering segments are shown, any suitable type of bending, winding, curving, etc., can also be used in particular embodiments. Also, applications other than portable computing devices or the like can also be accommodated in accordance with particular embodiments.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, “a particular embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. For example, distributed, networked systems, components and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “sand/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

In the claims:

1. A noise sampling detector, comprising:
a load portion;
an antenna pattern shaping portion coupled to the load portion, wherein the antenna pattern shaping portion comprises a plurality of meandering segments; and
an impedance matching circuit coupled to the antenna pattern shaping portion.

2. The noise sampling detector of claim 1, wherein the plurality of meandering segments comprises segments of varying length.

3. The noise sampling detector of claim 2, wherein the varying length is configured to adjust a bandwidth of signal detection.

4. The noise sampling detector of claim 1, wherein the plurality of meandering segments comprises segments of varying width.

5. The noise sampling detector of claim 4, wherein the varying width is configured to change a shape of an antenna pattern.

6. The noise sampling detector of claim 1, wherein the impedance matching circuit comprises a transformer.

7. The noise sampling detector of claim 1, wherein the impedance matching circuit comprises a series or shunt inductor.

8. The noise sampling detector of claim 1, having dimensions of about 20 mm by about 20 mm.

9. The noise sampling detector of claim 1, having dimensions of about 4 mm by about 16 mm.

10. The noise sampling detector of claim 1, having a thickness of less than about 100 μm.

11. The noise sampling detector of claim 1, configured to detect noise, interference, and spurs in a received electromagnetic signal.

12. A noise sampling detector, comprising:
a load portion;
an antenna pattern shaping portion coupled to the load portion, wherein the antenna pattern shaping portion comprises one or more notches on one or more sides in a square stub arrangement; and
an impedance matching circuit coupled to the antenna pattern shaping portion.

13. The noise sampling detector of claim 12, wherein each notch comprises a width and a depth.

14. The noise sampling detector of claim 13, wherein the width and the depth are equal.

15. The noise sampling detector of claim 12, wherein the width and the depth are varied to adjust a resonance frequency.

16. The noise sampling detector of claim 12, having dimensions of about 14 mm by about 14 mm.

17. The noise sampling detector of claim 12, having a thickness of less than about 100 μm.

18. The noise sampling detector of claim 12, wherein the impedance matching circuit comprises a transformer.

19. The noise sampling detector of claim 12, wherein the impedance matching circuit comprises a series or shunt inductor.

20. The noise sampling detector of claim 12, configured to detect noise, interference, and spurs in a received electromagnetic signal.

21. The noise sampling detector of claim 12, configured for a global positioning system (GPS) receiver.

22. A system for detecting and canceling noise, the system comprising:
means for receiving an electromagnetic signal for a first signal path;
means for amplifying and filtering the received signal to provide an amplified signal;
means for detecting noise in a second signal path; and
means for canceling the detected noise from the first signal path.
